(19) United States
(12) Patent Application Publication
(10) Pub. No.: US 2013/0202860 A1
(43) Pub. Date: Aug. 8, 2013

(54) CHLORINE-FREE INK AND COATING COMPOSITIONS & A METHOD FOR PRINTING ON UNTREATED POLYOLEFIN FILMS WITH IMPROVED ADHESION

(71) Applicants: Huanyu Wei, Fair Lawn, NJ (US); Youichi Abe, Ridgewood, NJ (US); Helen Rallís, New Providence, NJ (US)

(72) Inventors: Huanyu Wei, Fair Lawn, NJ (US); Youichi Abe, Ridgewood, NJ (US); Helen Rallís, New Providence, NJ (US)

(21) Appl. No.: 13/817,402

(22) PCT Filed: Aug. 18, 2011
(86) PCT No.: PCT/US11/48209

§ 371 Date: Apr. 11, 2013

Related U.S. Application Data
(60) Provisional application No. 61/374,706, filed on Aug. 18, 2010.

(51) Int. Cl. C09D 133/06

(52) U.S. Cl. CPC C09D 133/06
USPC 428/196; 524/563; 524/317; 524/376; 524/413; 524/35; 524/169; 524/267; 427/256; 427/358; 427/428.01; 427/427.6; 427/240; 427/420; 427/430.1; 427/429; 427/393.5; 428/195.1

(57) ABSTRACT

Provided are chlorine-free ink and coating compositions that demonstrate improved adherence when applied to untreated flexible plastic film substrates. The provided compositions eliminate the need for a separate step of pre-treating a plastic film before applying an ink or coating composition. Also provided are methods for producing a printed article using the provided ink and coating compositions and methods of adhering chlorine-free inks or coatings that exhibit improved adhesion characteristics to untreated plastic films.

### RELATED APPLICATIONS

Benefit of priority is claimed to U.S. Provisional Application Ser. No. 61/374,706, to Huanyu Wei, Youichi Abe and Helen Rallis, filed on Aug. 18, 2010, entitled “CHLORINE-FREE INK AND COATING COMPOSITIONS & A METHOD FOR PRINTING ON UNTREATED POLYOLEFIN FILMS WITH IMPROVED ADHESION.” Where permitted, the subject matter of this application is incorporated by reference in its entirety.

### FIELD OF INVENTION

Chlorine-free ink and coating compositions that demonstrate improved adherence when applied to untreated flexible plastic film substrates are provided. Compositions that eliminate the need for a separate step of pre-treating a plastic film before applying an ink or coating composition are provided. Methods for producing a printed article using the ink and coating compositions described herein are provided. Methods of adhering chlorine-free inks or coatings that exhibit improved adhesion characteristics to untreated plastic films also are provided.

### BACKGROUND

Flexible plastic films such as polyolefin films, are becoming more and more widely used in the packaging industry. Compared to rigid plastic substrates, polyolefin films used in packaging are typically much thinner and more flexible which makes for a challenge in developing inks and coatings which will adhere to these films. Acceptable adhesion of an ink or coating to these plastic films is essential for achieving desirable properties in packaging applications.

Inks and coatings containing chlorine are widely employed for various applications in the printing and packaging industries. Chlorinated copolymers used in inks and coatings are often necessary to achieve acceptable adhesion to untreated polyolefin films, solubility in solvent and compatibility with other copolymers and resins. However, chlorine-containing copolymers are becoming more unfavorable as components in ink and coating compositions, used in packaging printing, especially food packaging printing, due to the toxicity and poor recyclability of chlorine-containing compounds.

To overcome the barrier to printing on an untreated polyolefin film, it is common practice in the printing and coating industry to apply surface treatments before printing on them in order to increase the surface energy and provide a relatively polar surface that will be more receptive to inks and coatings. However it is becoming increasingly desirable to print directly onto untreated plastic films in many packaging applications. Accordingly, there exists a need for compositions that can be applied directly to untreated flexible plastic film substrates that demonstrate acceptable adhesion. Additionally, there exists a need for methods of applying an ink or coating that exhibits acceptable adhesion to untreated plastic films without the need for a pre-treatment step.

### SUMMARY

Provided herein are chlorine-free ink and coating compositions containing solvent, water or a combination thereof; copolymer; and colorant. The compositions provided herein demonstrate improved adherence when applied to untreated flexible plastic film substrates and thus eliminate the need for a separate step of pre-treating a plastic film before applying an ink or coating composition. Also provided herein are methods for producing a printed article using the provided ink and coating compositions and methods of adhering chlorine-free inks or coatings that exhibit improved adhesion characteristics to untreated plastic films. The methods provided herein result in the formation of a dried layer of a composition provided herein that exhibits enhanced shrinkability, flexibility, scuff resistance, heat resistance, block resistance, crinkle resistance and scratch resistance.

### DETAILED DESCRIPTION

A. Definitions

B. Compositions
1. Solvent
2. Copolymer
3. Colorant
4. Additional components
   a. Resins
   b. Coalescents and Plasticizers
   c. Waxes
   d. Silicones
   e. Stabilizers
5. Exemplary compositions

C. Methods

D. Examples

### A. DEFINITIONS

The definitions of the technical and scientific terms provided herein encompass definitions intended at the time. These definitions are not meant to be restrictive, as there can be other aspects to the definitions that are not recited, such as those commonly understood by one of skill in the art to which the invention(s) belong. All patents, patent applications, published applications and publications, websites and other published materials referred to throughout the entire disclosure herein, unless noted otherwise, are incorporated by reference in their entirety. In the event that there are pluralities of definitions for terms herein, those in this section prevail. Where reference is made to a URL or other such identifier or address, it is understood that such identifiers can change and particular information on the internet can come and go, but equivalent information is known and can be readily accessed, such as by searching the internet and/or appropriate databases. Reference thereto evidences the availability and public dissemination of such information.

It is to be understood that both the foregoing general description and the following detailed description are exemplary and explanatory only and are not restrictive of the subject matter claimed. In this application, the use of the singular includes the plural unless specifically stated otherwise. In this application, the use of “or” means “and/or” unless stated otherwise. Furthermore, use of the term “including” as well as other forms, such as “includes,” and “included” is not limiting.

As used herein, ranges and amounts can be expressed as “about” a particular value or range. “About” also includes the exact amount. Hence “about 10%” means “about 10%” and also “10%.”

As used herein, “optional” or “optionally” means that the subsequently described event or circumstance does or does not occur, and that the description includes instances where the event or circumstance occurs and instances where it does not. For example, an optionally substituted group means that the group is unsubstituted or is substituted.

As used herein, the singular forms “a,” “an” and “the” include plural referents unless the context clearly dictates otherwise. Thus, for example, reference to a composition comprising “a solvent” includes compositions with one or a plurality of solvents.

As used herein, a “combination” refers to any association between two or more items. The association can be spatial or refer to the use of the two or more items for a common purpose.

As used herein, a “composition” refers to any mixture of two or more products or compounds (e.g., solvents, resins, additives, etc.). It can be a solution, a suspension, liquid, powder, a paste, aqueous or non-aqueous formulations or any combination thereof.

As used herein, “homogeneous” with reference to a composition means that the components are in the liquid phase as a mixture, including as a solution or suspension.

As used herein, “improved adhesion” or “enhanced adhesion” refers to a greater amount of adhesion exhibited by the composition to untreated flexible plastic film substrates when dried, as compared to a conventional ink or coating composition.

As used herein, a substrate is “rigid” when the plane, curvature, or geometry of the substrate cannot be easily distorted. Rigid substrates can undergo temperature-induced distortions due to thermal expansion, or become flexible at temperatures above a glass transition.

As used herein, “flexible” or “flexibility” refers to a substrate's ability to bend, crease, fold, roll, crumple, twist, or compress with minimal or substantially no damage to the substrate. The object is capable of returning back to a portion of its original shape or position. A substrate is flexible when it can be reversibly moved between flat and curved geometries. Flexible substrates include, but are not limited to, polymers (e.g., plastics), woven fibers, thin films, metal foils, composites thereof, laminates thereof, and combinations thereof.

As used herein, the term “colorant” generally refers to a color extender, dye, pigment, lake, toner, other agent, or a combination thereof, used to impart a color to a material. In addition, the term “colorant” can include inorganic, organic, water-soluble and water-insoluble substances. “Dye” means a substance that is soluble in a solvent and that is used to impart color. Dyes are typically translucent and absorb but do not scatter light. Dyes include fluorescent dyes, phosphorescent dyes, pearlescent dyes, and conventional dyes. The term “pigment,” as used herein, can be organic and inorganic substances, and are used to impart color.

As used herein, “film forming” or “film formation” refers to compositions that can form an adherent continuous film on a substrate upon removal of any solvents or carriers present in the composition or upon drying at ambient or elevated temperature.

The term “coating,” as used herein, generally includes coatings that completely cover a surface, or portion thereof, as well as coatings that may only partially cover a surface, such as those coatings that after drying leave gaps in coverage on a surface. When the coatings described herein are described as being applied to a surface, it is understood that the coatings need not be applied to, or that they cover the entire surface. For instance, the coatings will be considered as being applied to a surface even if they are only applied to modify a portion of the surface.

As used herein, “opacity” refers to the property of a substrate or printed substrate which measures the capacity of the substrate to hide or obscure from view an object placed behind the substrate relative to the point from which observation is made. A substrate high in opacity will not permit much, if any, light to pass through the substrate. A substrate having low opacity will permit much, if not nearly all, light to pass through the substrate. Opacity can range from 0 to 100%.

As used herein, the term “hardness” refers to the property of a composition of material that enables it to resist plastic deformation, usually by penetration. The term hardness also can refer to resistance to bending, scratching, abrasion or cutting. The usual method to achieve a hardness value is to measure the depth or area of an indentation left by an indenter of a specific force applied for a specific time. Hardness can be measured at any point and after any known treatment such as rolling and annealing.

The term “scratch,” as used herein, refers to physical deformations resulting from mechanical or chemical abrasion. The term “scratch resistance,” as used herein, refers to the ability of a material to resist damage that can lead to visible, deep or wide trenches.

As used herein, “scuff” means to move or remove some portion of the composition off of the substrate. “Scuff resistance” refers to the ability of a print to resist removal of the composition when a moving object makes contact with the surface.

As used herein, the term “block resistance” is defined as the capability of a coating, when applied to two facing surfaces, not to stick to itself upon contact when pressure is applied. Block resistance is measured on a scale of 0 to 10, with 10 being the best (i.e., the coating shows no signs of sticking to itself).

As used herein, “shrinkability” refers to the capability of a material to decrease in its length in the given direction, or dimension, in response to the transmission of thermal energy into the material. Shrinkability is measured by wrapping a print around two bottles and shrinking the print using a hot air gun in order to make a tight fit. A material exhibits acceptable shrinkability if no stretch marks are visible in the printed area.

As used herein, the term “heat-resistant” refers to the ability of an ink or coating composition or an article formed from an ink or coating composition to resist transfer of ink after wrapping the print in aluminum foil and exposing the print to a pressure of 40 psi at 220-250° F. for 1 second.

As used herein, “crinkle resistance” is the ability of a printed article to retain the ink printed on the surface after crinkling the surface of the print ten times back and forth.

As used herein, “lamination bond strength” is the strength of the adhesive force between an ink or coating composition and a plastic substrate.

### B. COMPOSITIONS

Provided herein are chlorine-free ink and coating compositions. The chlorine-free compositions demonstrate improved adherence when applied to untreated flexible plastic film substrates over known ink compositions that are applied to untreated substrates without first treating the substrate. Additionally, the compositions provided herein eliminate the need for a separate step of treating a plastic film before applying an ink composition. In addition to improved adhesion, the compositions also exhibit desirable properties such as hardness, scuff resistance, shrinkability, flexibility, heat resistance, block resistance, crinkle resistance, scratch resistance and opacity. Due to these properties, the compositions are advantageous over existing prior art inks and coatings. The compositions provided herein are compatible for use with untreated flexible plastic films, such as polyolefin films. The compositions provided herein also permit printing directly onto films, since no pre-treatment step is required.

For example, the compositions provided herein can be applied to untreated polyolefin films. Compared to rigid plastic substrates, polyolefin films used in packaging are typically much thinner and more flexible which makes for a challenge in developing inks and coatings which will adhere to these films. Generally, untreated plastic films, especially untreated polyolefin films, possess low surface energy and low polarity. It is very difficult to achieve satisfactory adhesion of known coatings or inks, such as water- and solvent-based inks, to the surface of the untreated polyolefin films because of the low surface energy and low polarity. Nevertheless, flexible plastic films, for example polyolefin films such as polypropylene, polyethylene and polyethylene terephthalate films, are becoming more and more widely used in the packaging industry. Thus, acceptable adhesion of an ink or coating to these plastic films is necessary for achieving desirable properties in packaging applications.

Since the compositions provided herein exhibit improved adhesion properties over prior art inks and coatings inks, they can be used as coatings and inks on untreated flexible plastic films and other untreated films. In methods and uses provided herein of adhering coatings and inks to flexible plastic films, for example untreated polyolefin films, the compositions exhibit adhesion under drying conditions that limit distortion of the film. For example, flexible plastic films are more heat sensitive than thick, rigid plastic films and more prone to distortion or melting. The methods provided herein limit the drying conditions required for coating and inks on press. Thus, by limiting distortion, the compositions provided herein achieve good quality coated or printed articles at acceptable print speeds.

It is common practice in the printing and coating industry to apply surface treatments to plastic films before printing on them in order to increase the surface energy and provide a relatively polar surface that will be more receptive to inks and coatings. Typical surface treatment methods include corona or flame treatment, or chemical treatments such as applying a coating or primer. Surface treatment methods act to provide a relatively polar surface more receptive to inks and coatings by increasing the surface energy of an untreated plastic film thereby enhancing printability and improving ink adhesion. However it is becoming increasingly desirable to print directly onto untreated plastic films in many packaging applications. The compositions that are provided herein can be used to produce a printed article without the need for an initial treatment step. Thus, also provided herein is a method for producing a printed article using the ink and coating compositions described herein.

Not wishing to be bound by any one theory, it is believed that the presence of a copolymer or an increased amount of copolymer that has an affinity to untreated plastic films in an ink or coating composition allows the composition to adhere to untreated plastic films without the need for a first pre-treatment step of the plastic substrate. The adhesive properties of ink or coating compositions are affected by several components in the composition, including colorants, solvents, resins and copolymers. Thus, in order to achieve acceptable adhesion, the composition must include the correct combination of components. The film-forming ability of a copolymer coupled with its molecular affinity for a substrate is extremely important in achieving acceptable adhesion. In the ink or coating compositions provided herein, a copolymer, particularly ethylene vinyl acetate copolymer, is included in the compositions, and the compositions adhere to untreated plastic films, particularly untreated polyolefin films, without the need for a first pre-treatment step. As demonstrated in Section E, Examples 2 and 3, solvent- or water-based ink compositions alone (without a copolymer) demonstrate poor or very poor adhesion to untreated polyolefin films. Thus, provided herein are ink or coating compositions that have an affinity for untreated plastic films, particularly untreated polyolefin films, where the affinity of the compositions can be attributed at least in part to the presence of an amount of or an increased amount of a copolymer, particularly a copolymer that exhibits affinity to an untreated plastic substrate, an example of such copolymer including an ethylene vinyl acetate copolymer. The compositions provided herein exhibit improved adhesion to an untreated plastic substrate when compared to solvent- or water-based inks that do not include such a copolymer.

The compositions provided herein contain solvent, copolymer and colorant. The following subsections describe exemplary solvents, copolymers and colorants for inclusion in the compositions herein. Other ingredients also can be included in the compositions provided herein. As described in Section C, the compositions can be used in various methods, including for use with untreated flexible films, and for applying ink directly to films without a pre-treatment step.

1. Solvent

The compositions provided herein include one or more solvents. In solvent-based ink or coating compositions, solvents are used as carriers or vehicles for resins, pigments and other additives. Solvents also can be used to adjust the viscosity of a printing ink or coating. Solvents are chosen based on one or more desirable properties, for example, ability to dissolve a copolymer, compatibility with the substrate, environmental concerns and viscosity. Suitable solvents include water or non-aqueous solvents, such as hydrocarbons, such as heptanes, hexanes and pentanes; cyclic hydrocarbons and substituted cyclic hydrocarbons, such as ethylcyclohexane; petroleum distillates, such as naphtha, petroleum ether and light aliphatic solvents; aromatic compounds, such as xylene and toluene; alkyl acetates, such as ethyl acetate, isopropyl acetate, butyl acetate, propylene glycol monomethyl ether acetate (PM acetate) and n-propyl acetate; glycols and glycol ethers, such as monopropylene glycol, dipropylene glycol, 1-ethoxy-2-propanol, 1-propoxy-propanol (PROPOSOL solvent P), propylene glycol n-propyl ether, n-butyl ether, diethylene glycol monobutyl ether, propylene glycol methyl ether and diacetone alcohol; and alcohols, such as butyl alcohol, ethanol, propanol, isopropanol and n-propanol.

In the compositions provided herein, the solvent can be a single solvent or can be a mixture of one or more solvents. For example, the mixture of solvents can be a hydrocarbon, a petroleum distillate and an alkyl acetate. Exemplary solvents used in the compositions provided herein are heptane, naphtha and n-propyl acetate. In some embodiments, the ratio of naphtha to heptane is or is about 10:1, 9:1, 8:1, 7:1, 6:1, 5:1, 4:1, 3:1, 2:1, 1.5:1, 1.3:1, 1.1:1 or 1:1 or less. In some embodiments, the ratio of naphtha to n-propyl acetate is or is about 15:1, 14:1, 13:1, 12:1, 11:1, 10:1, 9:1, 8:1, 7:1, 6:1, 5.5:1, 5:1, 4:1, 3:1, 2:1, 1.5:1, 1.3:1, 1.1:1 or 1:1 or less. In some embodiments, the ratio of heptane to n-propyl acetate is or is about 15:1, 14:1, 13:1, 12:1, 11:1, 10:1, 9:1, 8:1, 7:1, 6:1, 5.5:1, 5:1, 4:1, 3:1, 2:1, 1.5:1, 1.3:1, 1.1:1 or 1:1 or less.

In the compositions provided herein, the total amount of solvent as a percentage (%) by weight of the composition (wt %) can be, e.g., between from or between about from 1% to 60%, such as 1% to 10%, 1% to 15%, 1% to 25%, 1% to 30%, 1% to 40%, 1% to 50%, 5% to 10%, 5% to 15%, 5% to 25%, 5% to 30%, 5% to 40%, 5% to 50%, 10% to 20%, 10% to 30%, 10% to 40%, 10% to 50%, 15% to 25%, 15% to 30%, 15% to 35%, 15% to 40%, 15% to 45%, 15% to 50%, 20% to 30%, 20% to 40%, 20% to 50%, 25% to 30%, 25% to 35%, 25% to 40%, 25% to 45%, 25% to 50%, 25% to 60%, 30% to 40%, 30% to 50%, 30% to 60%, 40% to 50%, 40% to 55%, 40% to 60%, 45% to 50%, 45% to 55%, 45% to 60%, 50% to 60%, 50% to 55%, and 55% to 60%, by weight of the composition. Generally, the compositions contain less than 60 wt % solvent. For example, the compositions provided herein contain at least or about at least 1%, 3%, 5%, 7%, 10%, 12%, 15%, 17%, 19%, 20%, 21%, 22%, 23%, 24%, 25%, 26%, 27%, 30%, 35%, 40%, 42%, 45%, 48%, 50%, 55%, but less than 60% (wt %) total solvent.

In some embodiments, a non-aqueous primer can be used as the solvent in the compositions provided herein. In addition to solvent, some commercially available primers also include copolymer, generally at low levels, such as less than 5% weight of the primer composition. Primers that can be used as a solvent in the compositions provided herein can be any of the non-aqueous solvent based primers useful in coatings applications, particularly printing applications. The primer can be chosen based on one or more desirable properties, for example, adhesion ability to untreated films, ability to dissolve copolymers or compatibility with the substrate. Primers that can be used in the compositions provided herein can include one or more non-aqueous solvents, one or more copolymers, and optionally can contain other ingredients, such as resins, waxes and/or plasticizers.

Primers suitable for inclusion in the compositions provided herein as a portion or all of the solvent can contain one or more solvents. In particular are primers that contain non-aqueous solvents. Non-aqueous solvents in the primer can include hydrocarbons, such as heptanes, hexanes, pentanes, petroleum distillates (e.g., naphtha, petroleum ether, light aliphatic solvents, e.g., light aliphatic solvent naphtha); cyclic hydrocarbons and substituted cyclic hydrocarbons, such as ethylcyclohexane; aromatic compounds, such as xylene and toluene; alkyl acetates, such as ethyl acetate, isopropyl acetate and n-propyl acetate; and alcohols, such as butyl alcohol.

A primer that can be used as a solvent in the compositions provided herein optionally can include a polymer, e.g., a copolymer or oligomer. The polymer should dry to a non-tacky film with the required flexibility for the end use. The polymer can be present in solution. Alternatively, the polymer can be present in the form of an emulsion, e.g., an emulsion of a polymer, copolymer or oligomer in water. Many such water dispersible polymers, copolymers and oligomers will be known to the skilled person for use in coatings. The polymers contained in the primer can be the same copolymer as those used in the compositions provided herein. Exemplary polymers include, but are not limited to, polyethylene acrylic acid (EAA), polyethylenimine (PEI), and ethylene vinyl acetate (EVA) copolymer, including any modifications made to such polymers, such as cross-linking or formulation.

A wide range of primers can be used as the solvent or a portion of the solvent in the compositions provided herein, including any non-aqueous solvent based primer containing the components described herein that will be known to those of skill in the art. Commercially available primers that can be used as the solvent or a portion of the solvent in the compositions provided herein include, e.g., SunShrink HAPS free primer (Sun Chemical, Parsippany, N.J.), Topaz 17 Solution (Michelman, Cincinnati, Ohio), Plastoflex® Primer (Akzo Nobel, Amsterdam, Netherlands) and Eastman AP 550-1 adhesion promoter (Eastman, Kingsport, Tenn.).

2. Copolymer

Copolymers included in the chlorine-free one-coat ink and coating compositions provided herein are synthetic, chlorine-free copolymers. The copolymers are soluble at room temperature in the solvent chosen for use in the compositions provided herein. Synthetic copolymers are prepared by polymerization involving condensation or addition reactions between relatively small molecules. Any known method can be used to prepare the copolymers suitable for the compositions provided herein (see, e.g. U.S. Pat. Nos. 3,594,453; 3,607,986; and 3,624,183). Synthetic copolymers can be structurally modified to exhibit physical properties desired for the particular application.

Chlorine-containing copolymers are very unfavorable as components in ink and coating compositions, especially in packaging printing, more specifically in food packaging printing, due to the toxicity and poor recyclability of chlorine-containing organic compounds. However, chlorine-containing copolymers are often necessary in order to achieve acceptable adhesion to non-polar substrates, solubility in the solvent or compatibility with other resins. Generally, ink compositions, such as gravure inks and ink jet inks, and coating compositions, used as primers or protective and decorative coatings, require the use of chlorinated polymers, such as chlorinated polypropylene and chlorinated ethylene vinyl acetate copolymer, in order to achieve acceptable adhesion to untreated polyolefin substrates.

JP 4-213375 describes a gravure ink composition for heat lamination containing an ethylene vinyl acetate copolymer, a chlorinated polypropylene and a vinyl chloride isobutyl vinyl ether copolymer. The chlorinated composition is used for printing on treated polyolefin film without using adhesive. U.S. Pat. No. 3,676,391 describes coating compositions used for priming untreated polyolefin substrates. The compositions comprise a mixture of chlorinated polyolefin and ethylene/vinyl acetate copolymer or acrylic copolymers. When the above-mentioned compositions are to be used as the sole protective coating or the finish coating for a polyolefin substrate (i.e. to be applied to an unprimed and otherwise unaltered polyolefinic surface) a combination of polymers and copolymers different from that used in the primer was found to be more desirable. The compositions used as a sole protective coating or finish coating comprise a mixture of chlorinated polyolefin and acrylic copolymers, without the use of ethylene vinyl acetate resin.

Chlorine-containing printing ink compositions are known in the art. For example, JP 57-209974 describes a printing ink composition that can be used in the printing of a laminating polyolefin film. The composition contains a binder obtained by blending a modified ethylene vinyl acetate copolymer such as a chlorinated, partially hydrolyzed ethylene vinyl acetate copolymer, with a chlorinated polypropylene. The chlorinated composition shows adhesiveness not only for polyolefin treated by a corona discharge treatment but also untreated polyolefin.

An aqueous gravure ink used for printing on a polypropylene tray is described in JP 2005232217 A2. The ink composition contains a chlorinated polypropylene graft-modified with maleic acid, a polyether urethane resin and an ethylene vinyl acetate copolymer. The chlorinated compositions provide adhesion to a polypropylene film as a substrate. JP 2006057056 A2 describes a chlorinated gravure ink for polypropylene films, containing a coloring agent, binder resin and ink solvent. The binder resin includes a chlorinated polypropylene and chlorinated ethylene vinyl acetate copolymer and the ink solvent does not include toluene.

U.S. Pat. No. 5,112,398 describes ink jet ink compositions used for printing on a cellulosic substrate such as plain paper. The compositions contain a mixture of a non-aqueous solvents, such as selected glycol ethers, a copolymer, such as an ethylene vinyl acetate copolymer, and a dyestuff. The copolymers used in the composition need to be completely soluble in the solvent at elevated operation temperatures, but substantially insoluble in the solvent at room temperature, while the dyestuff is soluble in the resin at room temperature and above but substantially insoluble in the solvent at room temperature.

The chlorine-free copolymers included in the compositions provided herein are soluble (dissolve) at room temperature in the solvent chosen for use in the composition. A copolymer is soluble in the solvent if a homogeneous solution of the copolymer in the solvent is formed without exposing the solution to elevated temperatures. The copolymer does not need to instantly dissolve in the solvent and can take up to or about several minutes or up to or about several hours. For example, the copolymer can require up to 5 minutes, up to 10 minutes, up to 15 minutes, up to 30 minutes, up to 1 hour, up to 2 hours or up to 5 hours or more to dissolve. One of skill in the art will know if a homogeneous solution of the copolymer and solvent has formed and can thus assess the solubility of a chosen copolymer in a solvent.

Ethylene vinyl acetate copolymer and modified ethylene vinyl acetate copolymer have been used in chlorine-containing and chlorine-free inks and coating compositions for different substrates, including treated and untreated polyolefin trays and films.

The copolymers provided herein are chlorine-free and exhibit strong adhesion to untreated plastic films, particularly untreated polyolefin films. Suitable copolymers provided herein include chlorine-free olefin homopolymers and chlorine-free olefin-type copolymers.

Exemplary chlorine-free copolymers that can be used in the compositions provided herein include, but are not limited to, a low-density polyethylene, ultra-low-density polyethylene, super ultra-low-density polyethylene, linear low-density polyethylene, high-density polyethylene, ultra-high-molecular-weight polyethylene, polypropylene, ethylene propylene copolymer, polymethyl pentene, propylene-l-butene random copolymer, propylene ethylene 1-butene random copolymer, copolymer prepared from propylene and an α-olefin having 5 to 12 carbon atoms, ethylene nonconjugated diene copolymer, propylene nonconjugated diene copolymer, ethylene propylene nonconjugated diene copolymer, polybutene, ethylene-vinyl acetate copolymer, ethylene vinyltrimethoxysilane copolymer, ethylene methyl acrylate copolymer, ethylene ethyl acrylate copolymer, ethylene methyl methacrylate copolymer, styrene butadiene block copolymer and its hydrogenated copolymer and any modified chlorine-free copolymers of the types listed above. These polymers or copolymers can be used alone or in combination of two or more. Chlorine-free copolymers and methods for producing them are know in the art, including those described in U.S. Pat. Nos. 6,462,130 and 6,495,629. Exemplary synthetic copolymers also are described in Clayton, M., “The Printing Ink Manual,” 5^{th} ed., Leach and Pierce, Eds. The Netherlands: Springer, pp. 225-252 (2007).

The chlorine-free copolymers are present in the compositions provided herein in an amount sufficient to provide good adhesion of the resulting composition to the plastic substrate. The total amount of copolymer as a percentage (%) by weight of the compositions provided herein (wt %) can be, e.g., between from or between about from 0.1% to 50%, such as 0.1% to 5%, 5% to 10%, 5% to 15%, 5% to 20%, 5% to 25%, 5% to 30%, 5% to 35%, 5% to 40%, 5% to 45%, 10% to 20%, 10% to 25%, 10% to 30%, 10% to 35%, 10% to 40%, 10% to 45%, 10% to 50%, 15% to 25%, 15% to 30%, 15% to 35%, 15% to 40%, 15% to 50%, 20% to 25%, 20% to 30%, 20% to 40%, 20% to 50%, 25% to 50%, 30% to 50% by weight of the composition. Generally, the compositions contain less than 50 wt % copolymer. For example, the compositions provided herein contain at least or about at least 0.1% , 1%, 2%, 3%, 4%, 5%, 6%, 7%, 8%, 9%, 10%, 11%, 12%, 13%, 14%, 15%, 16%, 17%, 18%, 19%, 20%, 23%, 25%, 30%, 32%, 35%, 40%, 42%, 45%, 48%, but less than 50% (wt %) total copolymer.

An exemplary chlorine-free ethylene copolymer that can be used in the compositions provided herein includes, e.g., a copolymer of ethylene with acrylic acid or vinyl acetate, such as an ethylene vinyl acetate. Ethylene vinyl acetate is prepared by copolymerization of ethylene and vinyl acetate. Vinyl acetate is synthesized by oxyacetylation of ethylene with acetic acid and oxygen. There also are many commercially available ethylene vinyl acetate copolymers including, but not limited to Elvax® 40L-03, 205W, 240W, 350, 440, 670, 770, 4320, 40W, 210W, 250, 360, 450, 560, 750, 880, 4355, 150, 220W, 260, 410, 460, 650Q, 760, 4260, 150W, 240, 265, 420, 470, 660, 760Q and 4310 from DuPont, Evatane® 18-150, 18-500, 20-20, 24-03, 28-03, 28-05, 28-25, 28-40, 28-150, 28-420, 28-800, 33-15, 33-25, 33-45, 33-400, 40-55 and 42-60 from Arkema, and others that will be known to those of skill in the art.

3. Colorant

The chlorine-free one-coat ink and coating compositions provided herein can include any chlorine-free colorant. Colorants give color to a substrate by altering its reflective characteristics. The colorant can be in the form of organic or inorganic pigments or dyestuffs or combinations thereof suitable for solvent and water based coatings and inks. Examples of colorants include, but are not limited to, organic pigments such as pigment yellow numbers 12, 13, 14, 17, 74, 115; pigment red numbers 2, 22, 23, 48:1, 48:2, 52, 53, 57:1, 122, 116, 170, 259, 266; pigment orange numbers 5, 16, 34, 36; pigment blue numbers 15, 15:1, 15:3, 15:4; pigment violet numbers 3, 23, 27; and pigment green number 7. Examples of inorganic pigments include, but are not limited to, iron oxides, titanium dioxides, chromium oxides, ferric ammonium ferrocyanides, ferric oxide blacks, pigment black number 7, and pigment white numbers 6 and 7. Examples of dyestuffs include, but are not limited to, azo dyes, anthraquinone dyes, azine dyes, xanthene dyes and combinations thereof. There are many commercially available pigments and dyes including, but not limited to, KRONOS® titanium dioxide pigment from Kronos Worldwide, Inc. (Dallas, Tex.), solvent-based inks such as polyamide pigment bases 52247-1165 G/S Blue, 2217NF-1165 Benz Yew and 46797-1190; nitrocellulose (NC) pigment bases 52217-0392 NC (blue), 46150-0392 NC (red), 22447-0392 NC (yellow) and 90513-0392 (black); and new process magenta XV-98, and water-based inks such as DPP-166, Aquaverse II, Aquaverse II D/T, AquaPro and Aquaverse V from Sun Chemical (Parsippany, N.J.).

In the compositions provided herein, the total amount of colorant as a percentage (%) by weight of the composition (wt %) can be, e.g., between from or between about from 0.1% to 90%, such as 0.1% to 10%, 0.5% to 10%, 1% to 10%, 1% to 15%, 1% to 25%, 1% to 30%, 1% to 40%, 1% to 50%, 1% to 60%, 1% to 70%, 1% to 80%, 5% to 10%, 5% to 15%, 5% to 25%, 5% to 30%, 5% to 40%, 5% to 50%, 5% to 60%, 5% to 70%, 5% to 80%, 5% to 90%, 10% to 20%, 10% to 30%, 10% to 40%, 10% to 50%, 10% to 60%, 10% to 70%, 10% to 80%, 10% to 90%, 15% to 25%, 15% to 30%, 15% to 35%, 15% to 40%, 15% to 45%, 15% to 50%, 15% to 60%, 15% to 70%, 15% to 80%, 15% to 90%, 20% to 30%, 20% to 40%, 20% to 50%, 20% to 60%, 20% to 70%, 20% to 80%, 20% to 90%, 25% to 30%, 25% to 35%, 25% to 40%, 25% to 45%, 25% to 50%, 25% to 60%, 25% to 70%, 25% to 75%, 25% to 80%, 30% to 40%, 30% to 50%, 30% to 60%, 30% to 70%, 30% to 75%, 40% to 50%, 40% to 55%, 40% to 60%, 40% to 65%, 40% to 70%, 40% to 75%, 40% to 80%, 40% to 85%, 40% to 90%, 45% to 50%, 45% to 55%, 45% to 60%, 45% to 65%, 45% to 70%, 45% to 75%, 45% to 80%, 45% to 85%, 50% to 55%, 50% to 60%, 50% to 65%, 50% to 70%, 50% to 75%, 50% to 80%, 50% to 85%, 55% to 60%. 55% to 65%, 55% to 70%, 55% to 75%, 55% to 80% and 55% to 85%, 55% to 90%, 60% to 70%, 60% to 80% and 60% to 90%. Generally, the compositions contain less than 90% (wt %) colorant. For example, the compositions provided herein contain at least or about at least 0.1% , 1%, 5%, 7%, 10%, 12%, 15%, 17%, 19%, 20%, 21%, 22%, 23%, 24%, 25%, 26%, 27%, 30%, 35%, 40%, 42%, 45%, 48%, 50%, 55%, 60%, 65%, 70%, 75%, 80%, 85%, but less than 90% total colorant.

4. Additional Components

The chlorine-free one-coat ink and coating compositions provided herein optionally can include components such as any of resins, coalescents, plasticizers, waxes, silicones, stabilizers or combinations thereof. The additional components are chosen based on one or more desirable properties of the composition and printed article, such as adhesion, film formation, hardness, scuff resistance, shrinkability, flexibility, heat resistance, block resistance, crinkle resistance, scratch resistance and opacity.

a. Resins

Chlorine-free resins optionally can be incorporated in the ink and coating composition to improve performance properties, e.g., hardness, scratch, scuff and rub resistance, and crinkle and block resistance. Resins used in the compositions provided herein can be natural resins or synthetic resins. Suitable resins for use in the ink and coating compositions described herein include, but are not limited to, nitrocellulose resins, polyamide resins, acrylic resins, maleic resins, urethane resins, ketone resins, polyvinyl butyral resins, rosin resins, cellulose acetate propionate resins, alkyd resins, melamine resins and cellulose acetate butyrate resins. Examples of commercially available resins include 3-V-18 NC nitrocellulose varnish from Sun Chemical (Parsippany, N.J.) and 940-1071 polyurethane resin from Reichhold, Inc. (Durham, N.C.) and those that will be known to those of skill in the art. Exemplary synthetic resins also are described in Clayton, M., “The Printing Ink Manual,” 5^{th} ed., Leach and Pierce, Eds. The Netherlands: Springer, pp. 225-252 (2007).

When one or more resins are included in the compositions provided herein, the total amount of resin as a percentage (%) by weight of the compositions provided herein (wt %) can be, e.g., between from or between about from 0.1% to 50%, such as 0.1% to 1%, 0.1% to 10%, 0.5% to 1%, 0.5% to 5%, 0.5% to 10%, 1% to 10%, 1% to 15%, 1% to 25%, 1% to 30%, 1% to 40%, 5% to 10%, 5% to 15%, 5% to 25%, 5% to 30%, 5% to 40%, 10% to 20%, 10% to 25%, 10% to 30%, 10% to 35%, 10% to 40%, 15% to 25%, 15% to 30%, 15% to 35%, 15% to 40%, 20% to 30%, 20% to 35%, 20% to 40%, 25% to 30%, 25% to 35%, 25% to 40%, 30% to 35%, 30% to 40% or 40% to 50% by weight of the composition. For example, when one or more resins are included in the compositions provided herein, the compositions contain up to at or about 1%, 2%, 5%, 7%, 10%, 12%, 15%, 17%, 20%, 25%, 28%, 30%, 33%, 35%, 40%, 45% or 50%. Generally, the compositions provided herein contain less than 50 wt % resin.

b. Coalescents and Plasticizers

Coalescents and plasticizers commonly are used in inks and coatings. One or more chlorine-free coalescents or plasticizers or a combination thereof can be included in the compositions provided herein. The use of a coalescent or a plasticizer or a combination thereof allows good film formation of resins on polyolefin substrates by softening (plasticizing) the polymer particles and assisting in the formation of a continuous coating or film after applying to the substrate and allowing it to dry. Following application of a water-based or solvent-based ink or coating composition, the water or solvent in the composition will evaporate more quickly than most of the coalescent and/or plasticizer, thus allowing the coalescent and/or plasticizer to soften the resin and permit resin particles to fuse together to form a continuous film. Coalescents that can be included in the compositions provided herein include, but are not limited to, linear mono alkyl esters of diethylene glycol, including ethyl, n-propyl, n-butyl and n-hexyl ethers of diethylene glycol, methyl, ethyl or butyl cellosolve, butyl cellosolve acetate, butyl hexyl cellosolve, butyl hexyl carbinol acetate, tributoxyethyl phosphate and 1-(2,2,4-trimethyl)-1,3-pentanediol-isobutyrate.

Exemplary plasticizers that can be included in the compositions provided herein include dioctyl phthalate (DOP) and dibutyl phthalate (DBP); dioctyl adipate and isodecyl succinate; diethylene glycol dibenzoate, and pentaerythritol ester; butyl oleate and acetylricinoleic methyl ester; tricresyl phosphate trioctyl phosphate; polypropylene glycol adipate, butylene glycol adipate, a sulfonamide plasticizer, a citric acid ester, a dibutyl sebacate, triethyl citrate, epoxidized soybean oil and hydrogenated methyl rosinate and combinations thereof. Commercially available coalescents and plasticizers that can be used in the compositions provided herein include Ketjenflex® 8 and 9S, Citroflex® 2 and A4, Vikoflex® 7170, Hercolyn® D, Dowanol DPnB, Texanol™, Dowanol PPh, Propasol P, Eastman DB (butyl carbitol), Dowanol™ DPM, Eastman™ EB (butyl cellosolve), Eastman™ EEH, Eastman™ Optifilm Enhancer 400 and HALLCOTE® HECA.

When one or more coalescents are included in the compositions provided herein, the total amount of coalescent as a percentage (%) by weight of the compositions provided herein (wt %) can be, e.g., between from or between about from 0.1% to 15%, such as 0.1% to 1%, 0.1% to 10%, 0.5% to 1%, 0.5% to 1%, 0.5% to 10%, 1% to 10%, 1% to 15%, 1% to 25%, 1% to 30%, 1% to 40%, 5% to 10%, 5% to 15%, 5% to 25%, 5% to 30%, 5% to 40%, 10% to 20%, 10% to 25%, 10% to 30%, 10% to 35%, 10% to 40%, 15% to 25%, 15% to 30%, 15% to 35%, 15% to 40%, 20% to 30%, 20% to 35%, 20% to 40%, 25% to 30%, 25% to 35%, 25% to 40%, 30% to 35%, 30% to 40% by weight of the composition. For example, when a coalescent is included in the compositions provided herein, the compositions contain up to at or about 1%, 2%, 3%, 4%, 5%, 6%, 7%, 8%, 9%, 10%, 11%, 12%, 13%, 14% or 15%. Generally, the compositions provided herein contain less than 15 wt % coalescent.

When one or more plasticizers are included in the compositions provided herein, the total amount of plasticizer as a percentage (%) by weight of the compositions provided herein (wt %) can be, e.g., between from or between about from 0.1% to 15%, such as 0.1% to 1%, 0.1% to 10%, 0.5% to 1%, 0.5% to 1%, 0.5% to 10%, 1% to 10%, 1% to 15%, 1% to 25%, 1% to 30%, 1% to 40%, 5% to 10%, 5% to 15%, 5% to 25%, 5% to 30%, 5% to 40%, 10% to 20%, 10% to 25%, 10% to 30%, 10% to 35%, 10% to 40%, 15% to 25%, 15% to 30%, 15% to 35%, 15% to 40%, 20% to 30%, 20% to 35%, 20% to 40%, 25% to 30%, 25% to 35%, 25% to 40%, 30% to 35%, 30% to 40% by weight of the composition. For example, when a plasticizer is included in the compositions provided herein, the compositions contain up to at or about 1%, 2%, 3%, 4%, 5%, 6%, 7%, 8%, 9%, 10%, 11%, 12%, 13%, 14% or 15%. Generally, the compositions provided herein contain less than 15 wt % plasticizer.

c. Waxes

The ink and coating compositions provided herein can contain one or more waxes, for enhancing the properties of the composition. Suitable waxes for use in the compositions provided herein include natural waxes or synthetic waxes. Exemplary natural waxes include, but are not limited to, plant waxes, such as carnauba waxes, animal waxes, fossil waxes and petroleum waxes. Exemplary synthetic waxes include, but are not limited to, polyolefin waxes such as polyethylene waxes, polytetrafluoroethylene and fatty acid amide waxes. Commercially available waxes include, but are not limited to, S-390-C polyethylene wax, Teflon® and Crodamide™ ER.

Generally, waxes are used in amounts that will not make up more than at or about 15% of the total composition, and often can be used in amounts that will not make up more than at or about 10% of the total composition. In some embodiments, one or more than one wax is present in an amount up to at or about 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5% or 10% by weight of the composition.

d. Silicones

The ink and coating compositions provided herein can contain one or more silicones for enhancing the properties of the composition. Exemplary silicones are silicone oils. Exemplary silicone oils that can be included in the composition include an unmodified silicone oil, an alcohol-modified silicone oil, an alkyl-modified silicone oil, an amino-modified silicone oil, a carboxy-modified silicone oil, an epoxy-modified silicone oil, a fluorine-modified silicone oil, and a polyether-modified silicone oil. For example, an unmodified silicone oil can be any one or a combination of dimethyl silicone oil, methylphenyl silicone oil and methyl hydrogen silicone oil. Epoxy-modified silicone oils that can be included in the compositions provided herein can include any known epoxy-modified silicone oil, such as those that contain a dimethylsilicone backbone and an epoxy group on either one or both ends and/or an epoxy group as a side chain thereof. Exemplary alcohol-modified silicone oils include those sold under the tradename KF851 by Shin-Etsu Chemical Co., Ltd. and the tradename SF8422 by Dow Corning Toray Silicone Co., Ltd. An example of a commercially available alkyl-modified silicone oil is available under the tradename KF410 from Shin-Etsu Chemical Co., Ltd.

Generally, silicones are used in amounts that will not make up more than at or about 15% of the total composition, and often can be used in amounts that will not make up more than at or about 10% of the total composition. In some embodiments, one or more that one silicone is present in an amount up to at or about 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5% or 10% by weight of the composition.

e. Stabilizers

Some compositions provided herein include stabilizers. The stabilizers can include, e.g., epoxides, amines, phenolics and organic acids, and are incorporated to prevent ongoing side reactions which can occur on storage of the ink or finished print, such as reactions between ink or paint components. Stabilizers can inhibit breakdown of resins and/or reduce corrosion of metal containers.

Generally, stabilizers are used in amounts that will not make up more than at or about 15% of the total composition, and often can be used in amounts that will not make up more than at or about 10% of the total composition. In some embodiments, one or more that one stabilizer is present in an amount up to at or about 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5% or 10% by weight of the composition.

5. Exemplary Compositions

Provided herein are chlorine-free ink and coating compositions that include a solvent, such as an organic solvent, e.g., a petroleum distillate, a copolymer, such as an ethylene vinyl acetate copolymer, and a colorant, such as an organic pigment, that exhibit good adhesion to untreated plastic films, such as a flexible film, e.g., a polyolefin film. Exemplary of such compositions contain between or about between 1 wt % to 60 wt % of one or more solvents, such as organic solvents, e.g., hydrocarbons (e.g., heptane), petroleum distillates (e.g., naphtha, such as light aliphatic solvent naphtha) and alkyl acetates (e.g., n-propyl acetate), and in particular at or about or at least 1 wt %; a colorant at an amount between or about between 0.1 wt % to 75 wt %; and a copolymer (e.g., ethylene vinyl acetate) in an amount that is sufficient to provide acceptable adhesion of the resulting composition to a plastic substrate. For example, the compositions provided herein can contain between or about between 0.1 wt % to 25 wt % copolymer. In further examples, exemplary compositions provided herein also can contain up to or about 50 wt % resin, e.g., nitrocellulose varnish or, e.g., polyurethane resin; up to or about 10 wt % additive, such as a wax; and up to or about 15 wt % coalescents and plasticizers, e.g., a glycol ether coalescent and a citric acid ester plasticizer.

The following compositions are exemplary only and provide a platform from which adjustments can be made. It is understood that changes in the amounts of the various components can be made while retaining some if not all of the adhesion and other desirable properties. Further changes can be made by adding or removing components. For example, the type of copolymer can be changed.

For example, the exemplary compositions provided herein can contain 0.1 wt % to 50 wt % of a chlorine-free copolymer, e.g., ethylene vinyl acetate, and in particular at least or about at least or about 3 wt % of a chlorine-free copolymer, e.g. ethylene vinyl acetate; 1 wt % to 60 wt % solvents, for example a blend of heptane, light aliphatic solvent naphtha and n-propyl acetate, and in particular at least or about at least or about 25 wt % solvents, for example a blend of heptanes, naphtha and n-propyl acetate; and 0.1 wt % to 75 wt % of a colorant, and in particular at least or about at least or about 15 wt % of colorant. Exemplary compositions provided herein can contain between or about between 3 wt % to 15 wt % ethylene vinyl acetate; between or about between 25 wt % to 50 wt % solvents, for example between or about between 13 wt % to 25 wt % light aliphatic solvent naphtha, between or about between 12 wt % to 21 wt % heptane and between or about between 2.5 wt % to 5 wt % n-propyl acetate; and between or about between 15 wt % to 55 wt % colorant. For example, the compositions can contain at or about 12.5 wt % ethylene vinyl acetate, at or about 37.5 wt % of a blend of heptane, naphtha and n-propyl acetate, and at or about 50 wt % colorant. For example, the compositions can contain at or about 12.5 wt % ethylene vinyl acetate, at or about 16.1 wt % heptane, at or about 18 wt % naphtha, at or about 3.3 wt % n-propyl acetate, and at or about 50 wt % colorant.

Exemplary of the compositions provided herein that contain a chlorine-free copolymer, for example ethylene vinyl acetate; solvents, e.g., a blend of heptane, naphtha and n-propyl acetate; and colorant are those that contain up to or about up to 10 wt % wax and up to or about up to 50 wt % resin, for example nitrocellulose varnish. For example, the compositions can contain at or about 8.5 wt % ethylene vinyl acetate, at or about 47 wt % of a blend of heptane, naphtha and n-propyl acetate, at or about 27 wt % colorant, at or about 1.5 wt % wax, and at or about 16 wt % nitrocellulose varnish. For example, the compositions can contain at or about 8.5 wt % ethylene vinyl acetate, at or about 20.1 wt % heptane, at or about 22.5 wt % naphtha, at or about 4.15 wt % n-propyl acetate, at or about 27 wt % colorant, at or about 1.5 wt % wax, and at or about 16 wt % nitrocellulose varnish.

Exemplary of the compositions provided herein that contain a chlorine-free copolymer, e.g., ethylene vinyl acetate; organic solvents, e.g., a blend of heptane, light aliphatic solvent naphtha and n-propyl acetate; and colorant are those that contain up to or about up to 10 wt % wax; up to or about up to 50 wt % resin, e.g., a polyurethane resin; up to or about up to 15 wt % plasticizer, e.g., a citric acid ester; and up to or about up to 15 wt % coalescent, e.g., a glycol ether. For example, the compositions can contain at or about 3 wt % ethylene vinyl acetate, at or about 28 wt % of a blend of heptane, naphtha and n-propyl acetate, at or about 25 wt % colorant, at or about 1.25 wt % wax, at or about 36 wt % polyurethane resin, at or about 3 wt % citric acid ester, and at or about 4 wt % glycol ether. For example, the compositions can contain at or about 3 wt % ethylene vinyl acetate, at or about 12.1 wt % heptane, at or about 13.5 wt % naphtha, at or about 2.5 wt % n-propyl acetate, at or about 25 wt % colorant, at or about 1.25 wt % wax, at or about 36 wt % polyurethane resin, at or about 3 wt % citric acid ester, and at or about 4 wt % glycol ether.

Exemplary compositions provided herein can contain between or about between 3 wt % to 13 wt % ethylene vinyl acetate; between or about between 28 wt % to 48 wt % of a blend of heptane, light aliphatic solvent naphtha and n-propyl acetate; between or about between 25 wt % to 53 wt % colorant, between or about between 0.9 wt % to 1.6 wt % wax; and between or about between 4 wt % to 7 wt % coalescent. The compositions provided herein can further contain between or about between 15 wt % to 36 wt % resin.

Exemplary of the compositions provided herein that contain a chlorine-free copolymer, e.g., ethylene vinyl acetate; organic solvents, e.g., a blend of heptane, light aliphatic solvent naphtha and n-propyl acetate; and colorant are those that contain up to or about up to 10 wt % wax; up to or about up to 15 wt % plasticizer, e.g. a citric acid ester; and up to or about up to 15 wt % coalescent, e.g., a glycol ether. For example, the compositions can contain at or about 5 wt % or 6 wt % ethylene vinyl acetate; at or about 38 wt % or 44 wt % of a blend of heptane, naphtha and n-propyl acetate; at or about 52 wt % or 45 wt % colorant; at or about 1 wt % wax; at or about 2.5 wt % or 1.5 wt % citric acid ester; and at or about 2.5 wt % or 1.5 wt % glycol ether. For example, the compositions can contain at or about 5 wt % or 6 wt % ethylene vinyl acetate; at or about 16.4 wt % or 18.8 wt % heptane; at or about 18.3 wt % or 21.1 wt % naphtha; at or about 3.4 wt % or 3.9 wt % n-propyl acetate; at or about 52 wt % or 45 wt % colorant; at or about 1 wt % wax; at or about 2.5 wt % or 1.5 wt % citric acid ester; and at or about 2.5 wt % or 1.5 wt % glycol ether.

### C. METHODS

Provided herein are methods for producing a printed article that is a combination of an untreated flexible plastic film substrate and one or more layers of the chlorine-free ink and coating compositions provided herein without the need for an initial treatment step. Also provided herein are methods of adhering inks or coatings to untreated plastic films such as flexible polyolefin films, using chlorine-free ink and coating compositions that exhibit improved adhesion characteristics compared to known ink and coating compositions.

Flexible plastic films, for example polyolefin films such as polypropylene, polyethylene and polyethylene terephthalate films, are becoming more and more widely used in the packaging industry. Compared to rigid plastic substrates, polyolefin films used in packaging are typically much thinner and more flexible which makes for a challenge in developing inks and coatings which will adhere to these films. Thus, acceptable adhesion of an ink or coating to these plastic films is necessary for achieving desirable properties in packaging applications. Generally, it is very difficult to achieve satisfactory adhesion of known coatings or inks, such as water- and solvent-based inks, to the surface of the untreated polypropylene and polyethylene films because of the low surface energy and low polarity. This limits their utility in areas where printable surfaces are desired. Methods to improve printability of polyolefin substrates include surface treatment. Typical surface treatment methods include corona, plasma or flame treatment, or chemical treatments such as applying a coating or primer. These treatments can soften or ionize the surface of polyolefins and make the surface temporarily printable. For examples of surface treatment methods used on polyolefin films, see U.S. Pat. Nos. 5,330,831; 5,789,123; 5,496,635; 5,496,636; 4,732,786; 5,902,684; and 5,827,627. Frequently, the modifications made to the surface of polyolefin films are difficult and expensive to make. Moreover, these modifications often impair the clarity of polypropylene films. Thus, an acceptable method of coating an untreated polyolefin substrate in one-step is desired. The methods provided herein allow an ink or coating composition to be applied directly to an untreated flexible polyolefin film without the need for an initial treatment step.

The ink and coating compositions provided herein can be applied to flexible untreated plastic films by any method known to those of skill in the art including, but not limited to, flexographic, gravure, lithographic, digital, screen, slot die, knife, doctor blade, roll, rod, spray, spin, curtain, dip, flow, rotary screen, extrusion, hot melt or brush. For example, the compositions provided herein can be applied to any polyolefin film using a K bar or an anilox hand proofer. In the methods provided herein, the initial ink or coating layer can be between from or between about from 0.1μ to 35μ, such as 0.1μ to 35μ, 0.2μ to 30μ, 0.3μ to 25μ, 0.4μ to 20μ, 0.5μ to 15μ, 0.7μ to 10μ, 1μ to 5μ, 2μ to 4μ, 0.5μ to 25μ, 0.1μ to 0.5μ, 0.5μ to 5μ, 5μ to 10μ, 10μ to 25μ or 25μ to 35μ. Generally, the initial ink or coating layer on the untreated plastic film is about 0.5 to 25 microns (0. For example, the initial ink or coating layer using the methods provided herein is at least or about at least 0.1μ, 0.2μ, 0.3μ, 0.4μ, 0.5μ, 0.7μ, 1μ, 2μ, 4μ, 5μ, 7μ, 10μ, 15μ, 20μ, 25μ, 30μ or up to 35μ. Additional layers can be applied based upon the desired properties of the finished film product.

A typical drying schedule can be at or about room temperature, or at or about 50° C. or at or about 80° C. for at least about 5 seconds, but other drying temperature and times are possible depending on substrate, press speeds, and capabilities. Generally, the drying will be such that the printed film is not subject to heat distortion. To prevent distortion, the drying temperature/time is generally about 80° C. or lower for about 5-30 seconds, dependant on the heat sensitivity of the flexible plastic films, printing method and press speed.

In the methods provided herein, the drying temperature can be between from or between about from 0.1 to 1, 0.1 to 2, 0.1 to 3, 0.1 to 4, 0.1 to 5, 0.1 to 6, 0.1 to 7, 0.1 to 8, 0.1 to 9, 0.1 to 10, 0.1 to 11, 0.1 to 12, 0.1 to 13, 0.1 to 14, 0.1 to 15, 0.1 to 16, 0.1 to 17, 0.1 to 18, 0.1 to 19, 0.1 to 20, 1 to 5, 1 to 7.5, 1 to 10, 1 to 15, 1 to 20, 1 to 25, 1 to 30, 2 to 4, 2 to 6, 2 to 8, 2 to 10, 2 to 15, 2 to 20, 2 to 25, 3 to 6, 3 to 9, 3 to 15, 3 to 20, 3 to 25, 3 to 30, 4 to 6, 4 to 8, 4 to 10, 4 to 12, 4 to 15, 4 to 20, 4 to 25, 4 to 30, 5 to 7.5, 5 to 10, 5 to 15, 5 to 17.5, 5 to 20, 5 to 22.5, 5 to 25, 5 to 27.5, 5 to 30, 7.5 to 15, 7.5 to 25, 10 to 15, 10 to 20, 10 to 25, 10 to 30, 15 to 20, 15 to 25, 15 to 30, 20 to 25, 20 to 30 and 25 to 30 seconds.

In the methods provided herein, the drying time can be between from or between about from 20° C. and 30° C., 20° C. and 40° C., 20° C. and 50° C., 20° C. and 60° C., 20° C. and 70° C., 20° C. and 75° C., 25° C. and 30° C., 25° C. and 40° C., 25° C. and 50° C., 25° C. and 60° C., 25° C. and 70° C., 25° C. and 75° C., 30° C. and 35° C., 30° C. and 40° C., 30° C. and 50° C., 30° C. and 60° C., 30° C. and 70° C., 30° C. and 75° C., 30° C. and 80° C., 35° C. and 40° C., 35° C. and 50° C., 35° C. and 60° C., 35° C. and 70° C., 35° C. and 75° C., 35° C. and 80° C., 40° C. and 45° C., 40° C. and 50° C., 40° C. and 60° C., 40° C. and 70° C., 40° C. and 75° C., 40° C. and 80° C., 45° C. and 50° C., 45° C. and 60° C., 45° C. and 70° C., 45° C. and 75° C., 45° C. and 80° C., 50° C. and 55° C., 50° C. and 60° C., 50° C. and 65° C., 50° C. and 70° C., 50° C. and 75° C., 50° C. and 80° C., 55° C. and 60° C., 55° C. and 70° C., 55° C. and 75° C., 55° C. and 80° C., 60° C. and 65° C., 60° C. and 70° C., 60° C. and 75° C., 60° C. and 80° C., 65° C. and 70° C., 65° C. and 75° C., 65° C. and 80° C., 70° C. and 75° C., 70° C. and 80° C. and 75° C. and 80° C.

Any flexible untreated plastic film used in the packaging industry is suitable for use with the compositions provided herein. Examples of suitable films include, but are not limited to, polyolefin films such as polypropylene, polyethylene, polyethylene naphthalate and polyethylene terephthalate films, oriented polystyrene, nylon, polyvinyl chloride or non-woven film substrates. As is well known by those of ordinary skill in the art, polyolefins can be produced with Ziegler catalysts or single-site catalysts. For example, see U.S. Pat. Nos. 4,542,199; 6,034,027; 5, 539,124; 5,756,611; and 5,637,660.

Provided herein are methods of adhering inks or coatings to untreated plastic films such as flexible polyolefin films, using chlorine-free ink and coating compositions that exhibit improved adhesion characteristics compared to known ink and coating compositions. In addition to improved adhesion of the compositions provided herein to the untreated polyolefin film, the printed article that is produced also displays desirable characteristics including, but not limited to, scuff resistance, shrinkability/flexibility, heat resistance, block resistance, crinkle resistance and scratch resistance. Printed articles are tested for the desired characteristics dependent on the type of composition, substrate and end application. Methods for testing the characteristics are well known to those of skill in the art. For a description of exemplary testing methods, see, e.g. S., “The Printing Ink Manual,” 5^{th} ed., Leach and Pierce, eds. The Netherlands: Springer, pp. 846-854 (2007).

Exemplary of the methods provided herein is a method for producing a printed article that can have a layer of the compositions provided herein. For example, the layer of the composition can contain a chlorine-free copolymer, e.g., ethylene vinyl acetate; colorant; and additional components, e.g., resin, wax, coalescent, plasticizer, stabilizer and silicone. For example, the layer of the composition can contain between or about between 5 wt % to 15 wt % ethylene vinyl acetate copolymer; between or about between 20 wt % to 60 wt % colorant; between or about between 5 wt % to 40 wt % resin; between or about between 0.1 wt % to 1.6 wt % wax; between or about between 0.1 wt % to 8 wt % coalescent; between or about between 0.1 wt % to 10 wt % plasticizer; and up to or about up to 20 wt % stabilizers and silicones.

### D. EXAMPLES

### Example 1

### Measurement of Surface Energy of Treated and Untreated Polypropylene and Polyethylene Films

The total surface energy, a combination of dispersion energy and polar energy, of six commercially-available treated and untreated polypropylene and polyethylene films was measured using the contact angle method. The contact angle was measured using a FIBRO DAT 1100 dynamic absorption and contact angle tester (Thwing-Albert, West Berlin, N.J.) with two test liquids, water and methylene iodide. The measured contact angle values were used to calculate the total surface energy, dispersion energy and polar energy with Surface Calculator software (version 1.0; Sun Chemical, Parsippany, N.J.). Two treated films and four untreated films were tested: 1) 25 μm-thick TT treated biaxially-oriented polypropylene (BOPP) film (AmTopp, Livingston, N.J.); 2) 50 μm-thick (2 mil) treated polyethylene (PE) film (Exopack, Hoffman Estates, Ill.); 3) 25 μm-thick TTNT untreated BOPP film (AmTopp, Livingston, N.J.); 4) untreated polypropylene film (Exopack, Hoffman Estates, Ill.); 5) 50 μm-thick (2 mil) untreated PE film (Exopack, Hoffman Estates, Ill.); and 6) the print side of a Cryovac® D-955 untreated PE shrink film (Sealed Air Corporation, Elmwood Park, N.J.).

Table 1 shows the values of total surface energy (dyn/cm), dispersion energy (dyn/cm), polar energy (dyn/cm) and percent polarity of the films. The two treated films displayed the highest total surface energy and highest percent polarity as compared to the four untreated films. Because untreated polypropylene and polyethylene films have a much lower surface energy and polarity than treated polypropylene and polyethylene films, inks and coatings display poor adhesion to untreated films.

TABLE 1
Surface energy values of treated and untreated polypropylene and polyethylene films

| | | Total surface | Dispersion | Polar | Percent |
|---|---|---|---|---|---|
| | | energy | energy | energy | polarity |
| Sample | | (dyn/cm) | (dyn/cm) | (dyn/cm) | (%) |
| 1) | TT treated BOPP film (AmTopp) | 38 | 33.4 | 4.61 | 12.14 |
| 2) | 2 mil (50 μm) PE film, | 35.91 | 32.98 | 2.93 | 8.15 |
| | treated side (Exopack) | | | | |
| 3) | TTNT untreated BOPP film | 28 | 27.8 | 0.2 | 0.58 |
| | (AmTopp) | | | | |
| 4) | Untreated polypropylene film | 25.83 | 24.96 | 0.87 | 3.37 |
| | (Exopack) | | | | |
| 5) | 2 mil (50 μm) PE film, | 32.95 | 32.7 | 0.25 | 0.76 |
| | untreated side (Exopack) | | | | |
| 6) | D-955 untreated PE shrink film, print | 26.03 | 25.53 | 0.49 | 1.9 |
| | side (Sealed Air Corporation) | | | | |

### Example 2

### Adhesion of Commercially Available Solvent-Based Inks to Untreated Polyolefin Films

Prints were made on two of the untreated polyolefin films described in Example 1 (AmTopp TTNT untreated BOPP film (Film 3) and the untreated side of the Exopack 2 mil (50 μm) PE film (Film 5)) using commercially available solvent-based ink new process magenta XV-98, and polyamide pigment bases 52247-1165 G/S Blue and 2217NF-1165 Benz Yew (Sun Chemical, Parsippany, N.J.). The inks were applied using a K Control Coater (RK Printcoat Instruments, Ltd., England) equipped with a standard white (Bar No. 0) meter bar (RK Printcoat Instruments, Ltd., England). The films were dried in an oven at 80° C. for 10 seconds.

Adhesion was measured using the adhesion tape test method. A strip of Scotch® Cellophane Film Tape 610 (3M, St. Paul, Minn.) was placed along the length of each print and pressed down by thumb twice to ensure a close bond between the tape and the print. While holding the print down with one hand, the tape was pulled off the print at approximately a 180° angle to the print. Adhesion performance was measured by estimating the percent of ink removed from each print by the tape and rating the performance by estimating the amount of ink removed from the print. Adhesion test results that fell into either the “Excellent” (0-15% ink removed) or “Good” (16-35% ink removed) categories were considered acceptable, with “Excellent” preferable. Adhesion test results that fell into “Fail” (36-55% ink removed), “Poor” (56-75% ink removed) or “Very Poor” (76-100% ink removed) categories were considered unacceptable.

Three tape tests were performed for each print at two different speeds of tape pull: fast and slow. The percent of ink removed from each print was averaged among the three tests for each print at each speed as shown in Table 2.

TABLE 2
Ink removal of commercial solvent-based
inks on untreated polyolefin films

| | % ink removed from | | % ink removed from | |
|---|---|---|---|---|
| | AmTopp TTNT untreated | | Exopack untreated 2 | |
| | BOPP film (Film 3) | | mil PE film (Film 5) | |
| Solvent- | Fast pull | Slow pull | Fast pull | Slow pull |
| based ink | adhesion | adhesion | adhesion | adhesion |
| new process | 90 | 95 | 90 | 90 |
| magenta XV-98 | | | | |
| 52247-1165 G/S | 90 | 95 | 90 | 95 |
| Blue | | | | |
| 2217NF-1165 | 95 | 95 | 60 | 95 |
| Benz Yew | | | | |

The three commercially available solvent-based inks that were tested all had very poor or poor adhesion to untreated polyolefin films 3 and 5 as measured using the adhesion tape pull method with both fast and slow pull, demonstrating from 60% to 95% ink removal.

### Example 3

### Adhesion of Commercially Available Water-Based Inks to Untreated Polyolefin Films

Prints were made on two of the untreated polyolefin films described in Example 1 (AmTopp TTNT untreated BOPP film (Film 3) and the untreated side of the Exopack 2 mil (50 μm) PE film (Film 5)) using commercially available water-based inks DPP-166, Aquaverse II, Aquaverse II D/T, AquaPro and Aquaverse V (Sun Chemical, Parsippany, N.J.). The inks were applied using a K Control Coater (RK Printcoat Instruments, Ltd., England) equipped with a standard white (Bar No. 0) meter bar (RK Printcoat Instruments, Ltd., England). The films were dried in an oven at 80° C. for 10 seconds.

Adhesion was measured using the adhesion tape test method and rated as described in Example 2. Three tape tests were performed for each print at two different speeds of tape pull: fast and slow. The percent of ink removed from each print was averaged among the three tests for each print at each speed as shown in Table 3.

TABLE 3
Ink removal of commercial water-based
inks on untreated polyolefin films

| | % ink removed from | | % ink removed from | |
|---|---|---|---|---|
| | AmTopp TTNT untreated | | Exopack untreated 2 | |
| | BOPP film (Film 3) | | mil PE film (Film 5) | |
| Water- | Fast pull | Slow pull | Fast pull | Slow pull |
| based ink | adhesion | adhesion | adhesion | adhesion |
| DPP-166 | 95 | 90 | 95 | 90 |
| Aquaverse II | 90 | 95 | 70 | 75 |
| Aquaverse II D/T | 90 | 85 | 75 | 65 |
| AquaPro | 95 | 90 | 90 | 95 |
| Aquaverse V | 85 | 85 | 95 | 95 |

The five commercially available water-based inks that were tested all had poor or very poor adhesion to untreated polyolefin films 3 and 5 as measured using the adhesion tape pull method with both fast and slow pull, demonstrating from 65% to 95% ink removal.

### Example 4

### Adhesion of a Chlorine-Free EVA Copolymer Solvent Solution Composition to Treated and Untreated Polyolefin Films

An ethylene vinyl acetate (EVA) copolymer solvent solution was prepared by dissolving 20g Elvax® 40W ethylene vinyl acetate copolymer pellets (DuPont, Wilmington, Del.) into 100g chlorine-free SunShrink HAPS free primer solution (Product No. AAKFS0617248; Sun Chemical, Parsippany, N.J.) at standard laboratory ambient conditions (temperature=22° C.±2; relative humidity=40%±10). The solid content of the chlorine-free EVA solvent solution was determined to be about 25 wt % EVA by a Sartorius Moisture Analyzer MA 51 (Sartorius AG, Germany).

The chlorine-free EVA copolymer solvent solution was mixed with solvent-borne polyamide pigment base 46797-1190 (Sun Chemical, Parsippany, N.J.) in a 1:1 solid ratio of resin solid to pigment solid by using a Speedmixer™ DAC 150 FVZ-K mixer (Hauschild, Germany) at 3000 rpm for 2 minutes.

Prints were made on two of the untreated polyolefin films described in Example 1 (AmTopp TTNT untreated BOPP film (Film 3) and the untreated side of the Exopack 2 mil (50 μm) PE film (Film 5)) using the chlorine-free EVA copolymer solvent solution composition. Prints were also made on two treated polyolefin films, AmTopp TT treated BOPP film (Film 1) and the treated side of the Exopack 2 mil (50 μm) PE film (Film 2), using the chlorine-free EVA copolymer solvent solution composition. The composition was applied to the films using a K Control Coater (RK Printcoat Instruments, Ltd., England) equipped with a standard white (Bar No. 0) meter bar (RK Printcoat Instruments, Ltd., England). The films were dried in an oven at 80° C. for 10 seconds.

Adhesion was measured using the adhesion tape test method as described in Example 2, using either a strip of Scotch® Cellophane Film Tape 610 (3M, St. Paul, Minn.) or Scotch® Magic Tape (permanent) 810 (3M, St. Paul, Minn.). Three tape tests were performed using fast tape pull for each print and the adhesion performance was rated as described in Example 2. The percent of ink removed from each print was averaged among the three tests for each print as shown below in Table 4.

TABLE 4
Ink removal of the chlorine-free EVA copolymer solvent solution
composition on untreated and treated polyolefin films

| | | | 610 Tape fast | 810 Tape fast |
|---|---|---|---|---|
| | | Pigments | pull adhesion | pull adhesion |
| Substrate | Resin | dispersion | (% ink removed) | (% ink removed) |
| AmTopp TTNT untreated | Chlorine-free EVA | 46797-1190 | 5 | 20 |
| BOPP film (Film 3) | copolymer solvent | pigment base | | |
| | solution | | | |
| Exopack untreated 2 mil | Chlorine-free EVA | 46797-1190 | 2 | 2 |
| PE film (Film 5) | copolymer solvent | pigment base | | |
| | solution | | | |
| AmTopp TT treated BOPP | Chlorine-free EVA | 46797-1190 | 2 | 5 |
| film (Film 1) | copolymer solvent | pigment base | | |
| | solution | | | |
| Treated side of the | Chlorine-free EVA | 46797-1190 | 0 | 2 |
| Exopack 2 mil (50 μm) PE | copolymer solvent | pigment base | | |
| film (Film 2) | solution | | | |

The chlorine-free EVA copolymer solvent solution composition exhibits good or excellent adhesion to both treated and untreated polyolefin films. The composition had excellent adhesion to both untreated polyolefin Films 3 and 5 as measured using the cellophane 610 Tape with fast pull, demonstrating between 2 to 5% ink removal. The chlorine-free EVA copolymer solvent solution exhibited good or excellent adhesion to both untreated polyolefin Films 3 and 5 as measured using the permanent 810 Tape with fast pull, with between 2 and 20% ink removed.

### Example 5

### Preparation and Properties of a White Ink Composition Containing the Chlorine-Free EVA Copolymer Solvent Solution Used in Shrink Sleeve Applications

The chlorine-free EVA copolymer solvent solution described in Example 4 was used to formulate a white ink composition used for printing in shrink sleeve applications. The white ink composition was prepared according to the formula shown in Table 5 by mixing the chlorine-free EVA copolymer solvent solution with KRONOS® Titanium Dioxide pigment (KRONOS Worldwide, Inc., Dallas, Tex.), 3-V-18 NC nitrocellulose varnish (Sun Chemical, Parsippany, N.J.), coalescent solvent Texanol™ ester alcohol (2,2,4-trimethyl-1,3-pentanediolmono(2-methylpropanoate)) (Eastman Chemical Company, Kingsport, Tenn.), Crodamide™ ER wax (Croda Universal, Inc., England), S-390-C polyethylene wax (Shamrock Technologies, Inc., Newark, N.J.) and n-propyl acetate, using a Speedmixer™ DAC 150 FVZ-K mixer (Hauschild, Germany) at 3000 rpm for 2 minutes.

TABLE 5
White ink composition formula

| Components | Weight percent (wt %) |
|---|---|
| EVA solvent solution | 34.39 |
| KRONOS ® titanium dioxide | 26.75 |
| 3-V-18 NC varnish | 16.30 |
| Texanol ™ ester alcohol | 5.73 |
| Crodamide ™ ER | 0.77 |
| S-390-C | 0.77 |
| n-propyl acetate | 15.29 |
| Total | 100 |

Prints were made by applying the white ink composition shown in Table 5 to the untreated D955 PE shrink film (Film 6) described in Example 1 with a K Control Coater (RK Printcoat Instruments, Ltd., England) equipped with a standard white (Bar No. 0) meter bar (RK Printcoat Instruments, Ltd., England). The heat-sensitive films were dried by cool air gun at room temperature for 5 seconds. Adhesion was measured immediately after drying the prints using the adhesion tape test method and rating the adhesion performance as described in Example 2. Three tape tests were performed using fast tape pull. The percent of ink removed from each print was averaged among the three tests as shown below in Table 6.

Other properties desirable for shrink sleeve applications were tested, including scuff resistance, shrinkability/flexibility, heat resistance and block resistance, and are summarized in Table 6 below. Scuff resistance was tested using the SUTHERLAND® Ink Rub tester (Danilee Co., Corpus Christi, Tex.) by passing a two pound weight over the print for 50 strokes. If there was no visible ink rubbed off, the print passed the test. If ink rubbed off, the print failed.

Shrinkability/flexibility was tested by wrapping the print around two bottles and shrinking the print using a hot air gun in order to make a tight fit. If there were no visible “stretch marks” in the printed area, the print passed the test, otherwise the print failed. Heat resistance was tested with a Sentinel Heat Sealer (Sencorp Systems, Inc., Bloomfield. N.Y.). The print was wrapped by aluminum foil and exposed to a pressure of 40 psi at 220-250° F. for 1 second. If there was minimal or no ink transferred, the print passed the test, otherwise the print failed. Block resistance, the capability of an ink or paint not to stick to itself and the unapplied side of the substrate, was tested. The prints were folded and put in a block tester with a pressure of 50 psi at 120° F. and 67% relative humidity for 16 hours. If there was no visible ink transferred to the film, the print passed the test, otherwise the print failed.

TABLE 6
Properties of prints on D-955 untreated PE shrink
film (Film 6) using a white ink composition

| Property evaluated | Test results |
|---|---|
| 610 Tape fast pull adhesion | 0-10% ink removed |
| Scuff test | Pass |
| Shrinkability/flexibility | Pass |
| Heat resistance | Pass |
| Block resistance | Pass |

The white ink composition exhibited excellent adhesion to the D-955 untreated PE shrink film (Film 6) as well as good scuff resistance, shrinkability/flexibility, heat resistance and block resistance, properties important in shrink sleeve applications.

### Example 6

### Preparation and Properties of a White Ink Composition Containing the Chlorine-Free Eva Copolymer Solvent Solution Used for Surface Printing Applications

The chlorine-free EVA copolymer solvent solution described in Example 4 was used to formulate a second white ink composition used in surface printing applications. This white ink composition was prepared according to the formula shown in Table 7 by mixing the chlorine-free EVA copolymer solvent solution with KRONOS® Titanium Dioxide pigment (KRONOS Worldwide, Inc., Dallas, Tex.), 3-V-18 NC nitrocellulose varnish (Sun Chemical, Parsippany, N.J.), 940-1071 polyurethane resin (Reichhold, Inc., Durham, N.C.), Citroflex® A-4 plasticizer (Vertellus, Inc., Indianapolis, Ind.), coalescent solvent Dowanol™ DPnB glycol ether (dipropylene glycol n-butyl ether) (Dow, Midland, Mich.), Crodamide™ ER wax (Croda Universal, Inc., England), S-390-C polyethylene wax (Shamrock Technologies, Inc., Newark, N.J.) and solvents PM acetate (propylene glycol monomethyl ether acetate) (Eastman, Kingsport, Tenn.), PROPASOL P (propoxypropanol) (Dow, Midland, Mich.), and n-propanol, using a Speedmixer™ DAC 150 FVZ-K mixer (Hauschild, Germany) at 3000 rpm for 5 minutes.

TABLE 7
Second white ink composition formula

| Components | Weight percent (wt %) |
|---|---|
| EVA solvent solution | 12.46 |
| KRONOS ® titanium dioxide | 24.92 |
| 3-V-18 NC varnish | 23.36 |
| 940-1071 polyurethane resin | 12.46 |
| Citroflex ® A-4 | 3.12 |
| Dowanol DPnB | 3.74 |
| Crodamide ™ ER | 0.62 |
| S-390-C | 0.62 |
| PM acetate | 3.74 |
| Propasol P | 3.74 |
| n-propyl acetate | 11.22 |
| Total | 100 |

Prints were made by applying the white ink composition shown in Table 7 to the untreated Exopack polypropylene film (Film 4) described in Example 1 with a 440 line, 3.4 BCM anilox hand proofer (Harper Corp., Charlotte, N.C.). The films were dried at 50° C. for 10 seconds.

Adhesion was measured immediately after drying the prints using the adhesion tape test method rating the adhesion performance as described in Example 2. Three tape tests were performed using fast tape pull. The percent of ink removed from each print was averaged among the three tests as shown below in Table 8.

Crinkle resistance and scratch resistance, desirable properties for surface printing applications, also were measured and the results are summarized in Table 8 below. Crinkle resistance was tested by crinkling the surface of the print ten times, back and forth. If there was no visible ink rubbed off, the print passed the test. If ink rubbed off, the print failed. Scratch resistance was tested by using fingernail scratches on the surface of prints ten times, back and forth. If there was minimal or no ink removal observed, the print passed the test, otherwise the print failed.

TABLE 8
Properties of prints on untreated polypropylene
film (Film 4) using a white ink composition

| Property evaluated | Test results |
|---|---|
| 610 Tape fast pull adhesion | 0-5% ink removed |
| Crinkle resistance | Pass |
| Scratch resistance | Pass |

The second white ink composition exhibited excellent adhesion to the untreated polypropylene film (Film 4) as well as good crinkle resistance and scratch resistance, properties desirable for surface printing applications.

### Example 7

### Preparation and Properties of Red, Blue, Yellow and Black Ink Compositions Containing the Chlorine-Free EVA Copolymer Solvent Solution Used in Surface Printing Applications

The chlorine-free EVA copolymer solvent solution described in Example 4 was used to formulate red, blue, yellow and black ink compositions used in surface printing applications. The compositions were prepared by first formulating a color let down composition according to the formula shown in Table 9 by mixing the chlorine-free EVA copolymer solvent solution with Citroflex® A-4 plasticizer (Vertellus, Inc., Indianapolis, Ind.), coalescent solvent Dowanol™ DPnB glycol ether (dipropylene glycol n-butyl ether) (Dow, Midland, Mich.), Crodamide™ ER wax (Croda Universal, Inc., England), and solvents PM acetate (propylene glycol monomethyl ether acetate) (Eastman, Kingsport, Tenn.) and n-propanol , using a Speedmixer™ DAC 150 FVZ-K mixer (Hauschild, Germany) at 3000 rpm for 2 minutes.

The color let down composition containing the chlorine-free EVA copolymer solvent solution was then used to formulate the red, blue, yellow and black ink compositions using either solvent-borne nitrocellulose (NC) pigment bases 52217-0392 NC (blue), 46150-0392 NC (red), 22447-0392 NC (yellow) or 90513-0392 (black) (Sun Chemical, Parsippany, N.J.), and mixed with a Speedmixer™ DAC 150 FVZ-K mixer (Hauschild, Germany) at 3000 rpm for 2 minutes. The formulas of the ink compositions are shown in Table 10 below.

TABLE 9
Color let down composition formula

| Components | Weigh percent (wt %) |
|---|---|
| EVA solvent solution | 40.83 |
| PM acetate | 12.24 |
| Crodamide ™ ER | 2.04 |
| Citroflex ® A-4 | 5.44 |
| Dowanol DPnB | 2.72 |
| n-propanol | 36.73 |
| Total | 100 |

TABLE 10
Blue, red, yellow and black ink composition formulas

| | Blue | Red | Yellow | Black |
|---|---|---|---|---|
| | compo- | compo- | compo- | compo- |
| | sition | sition | sition | sition |
| Components | (wt %) | (wt %) | (wt %) | (wt %) |
| Color let down | 47.88 | 55.06 | 47.88 | 47.88 |
| composition | | | | |
| 52217-0392 NC | 52.12 | — | — | — |
| blue pigment base | | | | |
| 46150-0392 NC red | — | 44.94 | — | — |
| pigment base | | | | |
| 22447-0392 NC | — | — | 52.12 | — |
| yellow pigment base | | | | |
| 90513-0392 NC | — | — | — | 52.12 |
| black pigment base | | | | |
| Total | 100 | 100 | 100 | 100 |

Prints were made by applying either the blue, red, yellow or black ink composition shown in Table 10 to the Exopack untreated polypropylene film (Film 4) described in Example 1 with a 440 line, 3.4 BCM anilox hand proofer. The films were dried at 50° C. for 10 seconds. Adhesion was measured immediately after drying the prints using the adhesion tape test method and rating the adhesion performance as described in Example 2. Three tape tests were performed for each print using fast tape pull. The percent of ink removed from each print was averaged among the three tests as shown below in Table 11. Crinkle resistance and scratch resistance also were measured as described in Example 6 and the results are summarized in Table 11 below.

TABLE 11
Properties of prints on Exopack untreated polypropylene
film with the blue, red, yellow or black ink compositions

| | Blue | Red | Yellow | Black |
|---|---|---|---|---|
| | composi- | composi- | composi- | composi- |
| Property | tion test | tion test | tion test | tion test |
| evaluated | results | results | results | results |
| 610 Tape fast | 0-5% ink | 0-5% ink | 0-5% ink | 0-5% ink |
| pull adhesion | removed | removed | removed | removed |
| Crinkle resistance | Pass | Pass | Pass | Pass |
| Scratch resistance | Pass | Pass | Pass | Pass |

All four ink compositions based on the chlorine-free EVA copolymer solvent solution exhibited excellent adhesion (0-5% ink removal) to the untreated polypropylene film (Film 4) as well as good crinkle and scratch resistance, properties desirable for surface printing applications.

Since modifications will be apparent to those of skill in this art, it is intended that this invention be limited only by the scope of the appended claims.

1. An ink or coating composition, comprising:
a chlorine-free solvent;
a chlorine-free copolymer; and
a colorant;
wherein:
the composition coats and adheres to an untreated surface of a plastic substrate.

2. The composition of claim 1, wherein the solvent comprises water, an organic solvent or a combination thereof.

3. The composition of claim 2, wherein the organic solvent is selected from among hydrocarbons, cyclic hydrocarbons, substituted hydrocarbons, aromatic compounds, alkyl acetates, alcohols and petroleum distillates and combinations thereof.

4. The composition of claim 3, wherein the organic solvent is selected from among a heptane, hexane, pentane, naphtha, petroleum ether, ethylcyclohexane, xylene, toluene, propylene glycol monomethyl ether acetate, ethyl acetate, isopropyl acetate, n-propyl acetate and butyl alcohol and combinations thereof; or
the organic solvent comprises heptane, n-propyl acetate or naphtha or a combination thereof.

5.-6. (canceled)

7. The composition of claim 1, wherein:
the solvent is present in an amount of from 1% to 60% by weight of the composition;
the copolymer is present in an amount of from between 5% to 50% by weight of the composition; and
the colorant is present in an amount of from 0.1% up to 90% by weight of the composition.

8. (canceled)

9. The composition of claim 1, wherein the chlorine-free copolymer is selected from among a low-density polyethylene, ultra-low-density polyethylene, super ultra-low-density polyethylene, linear low-density polyethylene, high-density polyethylene, ultra-high-molecular-weight polyethylene, polypropylene, ethylene propylene copolymer, polymethyl pentene, propylene-l-butene random copolymer, propylene ethylene 1-butene random copolymer, copolymer prepared from propylene and an α-olefin having 5 to 12 carbon atoms, ethylene nonconjugated diene copolymer, propylene nonconjugated diene copolymer, ethylene propylene nonconjugated diene copolymer, polybutene, ethylene vinyl acetate copolymer, ethylene vinyl trimethoxysilane copolymer, ethylene methyl acrylate copolymer, ethylene ethyl acrylate copolymer, ethylene methyl methacrylate copolymer, styrene butadiene block copolymer and its hydrogenated copolymer or a combination thereof; or
the chlorine-free copolymer comprises an ethylene vinyl acetate copolymer.

10.-11. (canceled)

12. The composition of claim 1, wherein the colorant is selected from among an organic pigment, an inorganic pigment and a dye and combinations thereof.

13. The composition of claim 12, wherein:
the organic pigment is selected from among pigment yellow numbers 12, 13, 14, 17, 74, 115; pigment red numbers 2, 22, 23, 48:1, 48:2, 52, 53, 57:1, 122, 116, 170, 259, 266;
pigment orange numbers 5, 16, 34, 36; pigment blue numbers 15, 15:1, 15:3, 15:4; pigment violet numbers 3, 23, 27; and pigment green number 7; or
the inorganic pigment is selected from among iron oxides, titanium dioxides, chromium oxides, ferric ammonium ferrocyanides, ferric oxide blacks, pigment black number 7, and pigment white numbers 6 and 7 and combinations thereof; or
the dye is selected from among an azo dye, an anthraquinone dye, an azine dye and a xanthene dye.

14.-16. (canceled)

17. The composition of claim 1, wherein the composition further comprises one or more additional components selected from among a resin, a coalescent, a plasticizer, a wax, a silicone and a stabilizer.

18. The composition of claim 17, wherein when present:
the resin is present in an amount of from 0.1% to 40% by weight of the composition, and is selected from among a nitrocellulose resin, a polyamide resin, an acrylic resin, a maleic resin, a urethane resin, a ketone resin, a polyvinyl butyral resin, a rosin resin, a cellulose acetate propionate resin, an alkyd resin, a melamine resin and a cellulose acetate butyrate resin and combinations thereof; and/or
the coalescent is present in an amount less than 15% by weight of the composition, and is selected from among a glycol ether, linear mono alkyl esters of diethylene glycol, ethyl or butyl cellosolve, butyl cellosolve acetate, butyl hexyl cellosolve, butyl hexyl carbinol acetate, tributoxyethyl phosphate and 1-(2,2,4-trimethyl)-1,3-pentanediol-isobutyrate, dipropylene glycol n-butyl ether, citric acid ester, glycol ether, butyl carbitol, butyl cellosolve, dipropylene glycol methyl ether, trimethyl-hydroxypentyl isobutyrate and combinations thereof; and/or
the plasticizer is present in an amount less than 15% by weight of the composition, and is selected from among a sulfonamide plasticizer, a citric acid ester plasticizer, a dibutyl sebacate, triethyl citrate, epoxidized soybean oil and hydrogenated methyl rosinate and combinations thereof; and/or
the wax is present in an amount up to 15% by weight of the composition, and is selected from among a plant wax, a polyolefin wax and a synthetic wax and combinations thereof; and/or
the silicone is present in an amount up to 15% by weight of the composition, and is a silicone oil selected from among an unmodified silicone oil, an alcohol-modified silicone oil, a fluorine-modified silicone oil, an amino-modified silicone oil, a carboxy-modified silicone oil and a polyether-modified silicone oil and a combination thereof; and/or
the stabilizer is present in an amount up to 15% by weight of the composition.

19.-23. (canceled)

24. The composition of claim 18, wherein the additional component is a sulfonamide plasticizer that comprises n-butylbenzenesulfonamide, a mixture of n-ethyl ortho-and para-toluene sulfonamide, n-cyclohexyl p-toluenesulfonamide or o,p-toluenesulfonamide or a combination thereof.

25.-29. (canceled)

30. The composition of claim 18, wherein the additional component is a silicone that is an unmodified silicone oil selected from among dimethyl silicone oil, methylphenyl silicone oil and methyl hydrogen silicone oil and combinations thereof.

31.-32. (canceled)

33. The composition of claim 1, wherein the composition contains no chlorinated component.

34. (canceled)

35. The composition of claim 1, wherein the composition is formulated as an ink or a coating.

36. The composition of claim 35, wherein the composition is formulated as an ink jet ink, a gravure printing ink, a lithographic printing ink, a screen printing ink, an intaglio printing ink or a digital printing ink.

37. (canceled)

38. The composition of claim 35, wherein the composition is formulated for application to a surface using a die, knife, doctor blade, roll, rod, spray, spin, curtain, dip, flow, gravure, rotary screen, extrusion, hot melt or brush; or
the plastic substrate is a flexible plastic film selected from among a polypropylene film, a polyethylene film, a polyolefin film, a polyester film, an oriented polystyrene film, a polyvinylchloride film, a nylon film or a combination thereof; or
the plastic substrate is a plastic film comprising a polypropylene copolymer film, a polyethylene copolymer film, a polethylene terephthalate film, a polethylene naphthalate film or a combination thereof.

39.-42. (canceled)

43. The composition of claim 1, wherein when dried, the composition forms a coating layer on the substrate that is 0.5 to 25 microns thick and exhibits enhanced adhesion to untreated flexible plastic film substrates compared to a conventional ink or coating composition and/or increased lamination bond strength to untreated flexible plastic film substrates compared to a conventional ink or coating composition.

44.-47. (canceled)

48. A printed article, comprising:
an untreated flexible plastic film having a first surface and a second surface; and
on at least one of the first surface or the second surface, a layer comprising a composition of claim 1, wherein the layer has a thickness of from 0.5 to 25 microns thick when dried.

49. (canceled)

50. The printed article of claim 48, wherein:
the untreated plastic film comprises a non-woven substrate or a polypropylene film, a polyethylene film, a polyolefin film, a polyester film, an oriented polystyrene film, a polyvinylchloride film, a nylon film or a combination thereof; or
the untreated plastic film comprises a polypropylene copolymer film, a polyethylene copolymer film, a polyethylene terephthalate film, a polyethylene naphthalate film or a combination thereof.

51.-53. (canceled)

54. A method of applying an ink or coating composition to a surface of a plastic substrate in one step, comprising:
without pre-treating a surface of a plastic substrate, applying to the surface a layer of the ink or coating composition of claim 1.

55. The method of claim 54, wherein:
the substrate is a plastic film that comprises a polypropylene film, a polyethylene film, a polyolefin film, a polyester film, an oriented polystyrene film, a polyvinylchloride film, a nylon film or a combination thereof; or
the plastic substrate is a flexible plastic film; or
the plastic film comprises a polypropylene copolymer film, a polyethylene copolymer film, a polyethylene terephthalate film, a polyethylene naphthalate film or a combination thereof.

56.-59. (canceled)

60. The method of claim 54, wherein:
the film contacts a food directly or indirectly; or
the film is a food packaging.

61. (canceled)

62. The method of claim 54, wherein:
the ink composition is applied to the surface by a method selected from among flexographic, gravure, lithographic, screen, intaglio, letter press and digital printing methods or combinations thereof; or
the coating composition is applied by a method selected from among slot die, knife, doctor blade, roll, rod, spray, spin, curtain, dip, flow, gravure, rotary screen, extrusion, hot melt, brush or gravure coating methods or a combination thereof.

63. (canceled)

64. The method of claim 54, further comprising the step of drying the ink or coating layer to a thickness of at least 0.1 micron thick, wherein the drying step comprises subjecting the layer to a temperature between 20° C. and 80° C. for a time that is 30 seconds or less, wherein the layer when dried exhibits a property selected from among shrinkability, flexibility, scuff resistance, heat resistance, block resistance, crinkle resistance and scratch resistance or a combination thereof.

65.-67. (canceled)
